(19) United States
(12) Patent Application Publication
(10) Pub. No.: US 2009/0125363 A1
(43) Pub. Date: May 14, 2009

(54) Method, apparatus and computer program for employing a frame structure in wireless communication

(75) Inventors: Frank Frederiksen, Klarup (DK); Troels E. Kolding, Klarup (DK); Gilles Charbit, Hampshire (GB); Xiang Guang Che, Beijing (CN)

Correspondence Address: HARRINGTON & SMITH, PC, 4 RESEARCH DRIVE, Suite 202, SHELTON, CT, 06484-6212, US

(73) Assignee: Nokia Siemens Networks Oy

(21) Appl. No.: 12/288,680

(22) Filed: Oct. 22, 2008

Related U.S. Application Data
(60) Provisional application No. 60/999,917, filed on Oct. 22, 2007.
(60) Provisional application No. 61/000,207, filed on Oct. 23, 2007.

(51) Int. Cl. G06Q 10/00; G06Q 90/00; G06F 17/00

(52) U.S. Cl. 705/8

(57) ABSTRACT

A frame structure for scheduling radio resources includes a first time slot, followed by a plurality of other time slots each having either a second length, or a first length that is approximately double the second length. Transmissions are sent in downlink ones of the other time slots and received in uplink ones of the other timeslots. In various embodiments, the first length is 1.35 ms/19 symbols and the second length is 0.675 ms/9 symbols; the first timeslot is downlink and has length 0.852 ms/12 symbols; there is an additional guard period of 26 microseconds between the first timeslot and the other timeslot that follows the first timeslot which is uplink and has the first length; there may also be a single symbol between the guard period and that uplink timeslot for uplink signaling; and all other timeslots that are downlink are of the second length.

### TECHNICAL FIELD

This application claims priority under 35 USC 1109(e) to U.S. Provisional Patent Application Nos. 60/999,917 (filed Oct. 22, 2007) and 61/000,207 (filed Oct. 23, 2007), the contents of which are incorporated by reference.

### TECHNICAL FIELD

The teachings herein relate generally to wireless communications and particularly relate to a frame structure used in such communications.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations and terms are herewith defined:

3GPP third generation partnership project

AMC adaptive modulation and coding

CCFI control channel format indicator (alternatively Cat0)

CP cyclic prefix

DL downlink

DwPTS downlink pilot time slot

GP guard period

HARQ hybrid automatic request

Node B base station, or evolved node B of an LTE system

E-UTRA evolved UTRA

FDD frequency division duplex

FS1 frame structure 1

FS2 frame structure 2

LTE long term evolution of 3GPP

MCS modulation and coding scheme

Node B base station or similar network access node

OFDM orthogonal frequency division multiplex

OS OFDM symbol

PRB physical resource block

RACH random access channel

TDD time division duplex

TS time slot

TTI transmit time interval

UDSP uplink downlink switching point

UL uplink

UpPTS uplink pilot time slot

UE user equipment (e.g., mobile equipment/station)

UMTS universal mobile telecommunications system

UTRA UMTS terrestrial radio access

3GPP is standardizing the long-term evolution (LTE) of the radio-access technology which aims to achieve reduced latency, higher user data rates, improved system capacity and coverage, and reduced cost for the operator. LTE has both TDD and FDD modes, and LTE TDD is reaching a final specification phase in 3GPP standardization. As presently specified the DL access technique will be OFDMA, and the UL access technique will be SC-FDMA. Two frame structure options for LTE TDD have been studied in 3GPP: FS1 and FS2. Following a recent decision in 3GPP RAN#37, it was decided at 3GPP TSG RAN #37; Riga, Latvia, 11-14 Sep. 2007 [see document RP-07051, attached to the priority documents as Exhibit A and entitled “WAY FORWARD FOR SIMPLIFYING LTE TDD”] that RAN1 shall investigate the possibility for an optimized LTE TDD mode based on frame structure 2, further optimizing performance and ensuring ease of implementation of FDD and TDD modes within the same E-UTRA equipment. See also Appendix B of the priority documents: 3GPP TR 25.814 v7.1.0 (2006-09); PHYSICAL LAYER ASPECTS. Frame structure type 2 as understood in the prior art is illustrated at FIG. 1.

In the description below, ms=millisecond and us=microsecond as is conventional. A 10 ms radio frame T_{f} in FIG. 1 is divided into two equally sized 5 ms radio sub-frames according to current understanding in LTE for FS2. One radio sub-frame consists of seven traffic time slots (designated TS0 to TS6 or #s 0 to 6 in FIG. 1). A synchronization and guard period SGP is disposed between TS0 and TS1, whose duration is 8448×Tₛ=0.275 ms including DwPTS of length 2572×Tₛ=83.72 us, GP1 of length 1536×Tₛ=50 us and UpPTS of length 4340×Tₛ=141.27 us. There is one pair of switching points within a 5 ms E-UTRA radio sub-frame structure. Besides the first guard period GP1 which is set between the DwPTS and UpPTS, there may be more guard periods UDSP, of length 288×Tₛ=9.375 us with short Cyclic Prefix (CP) or 256×Tₛ=8.33 us with extended CP to allow UL/DL switching point in 5 ms. The TTI length is 20736×Tₛ=0.675 ms, which is the same as duration of one traffic time slot. Areas of optimization identified in TR 25.814 (see Appendix B of the priority documents) include frame efficiency and UL coverage. FS2 frame structure has several drawbacks. Two main drawbacks relevant to these teachings are detailed below.

First, the layer 1/layer 2 (L1/L2) control channel overhead is higher than that of TDD Frame Structure type 1 (FS1), as FS2 TS length of 20736×Tₛ=0.675 ms is shorter than that of FS1 frame length of 30720×Tₛ=1 ms (see Appendix B of the priority documents). This results in a higher number of TTIs which requires more scheduling grants during a given period and may generate more data-non-associated feedback signaling such as acknowledgements/non-acknowledgements (ack/nack). A shorter TTI means smaller transmission time for UEs on the edge of the cell and result in UL coverage loss, even if allowing for (i) narrow-band frequency allocation at maximum UE power transmission; or (ii) higher frequency allocation with more robust AMC and HARQ. The first option (i) suffers from power limitation in the UE and may add significantly to inter-cell interference. The second option (ii) may result in smaller packet scheduling gains due to frequency chunk allocation becoming too large to fully utilize frequency selectivity of the channel.

The second drawback of FS2 relevant to these teachings is that the FS2 frame efficiency is smaller than that of FS1, for two main reasons:
Special TS (DwPTS, GP1 and UpPTS, denoted SGP in FIG. 1) in FS2 is rather inefficient.
   DwPTS only uses centered 6 PRB (i.e. 6×12=72 subcarriers) to carry the primary synchronization channel (P-SCH), the rest of subcarriers are unused, with a frame loss efficiency of up to ˜1.6% for the larger bandwidth option 20 MHz.
   The granularity or step size of GP is much more coarse/larger than that of TDD FS1—i.e. [1536×Tₛ=50 us, 5889×Tₛ=191.7 us or 26634×Tₛ=867 us] v.s. [n*(2048+144)×Tₛ=n*71.3 us (short-CP) or n*(2048+512)×Tₛ=n*83.3 us (long-CP)]
   According to the inventors' internal studies, the UpPTS serving as short RACH preamble results in a hard link loss of ˜7.8 dB compared to the normal RACH preamble used in FS1. The UpPTS can only be used as RACH, and hence will result in a further frame loss efficiency of up to ˜2.8% for the larger bandwidth option 20 MHz (when subcarriers are not used by RACH)
The short CP length of FS2 is ˜55% longer than that of TDD FS1 on DL—i.e. 228Ts/7.44 us (average with 512×Tₛ for OS #8 in slot 0, and 224×Tₛ otherwise) v.s. 146.3×Tₛ=4.75 us (average with 160×Tₛ for OS #0, and 144×Tₛ for OS #1 through #6). On the UL, the FS2 short CP length is about 41% longer than that in FS1.

It was agreed in the October 2007 3GPP RAN1 meeting to take FS2 as the starting point and improve its performance. Several companies have made various proposals in 3GPP. For example, attached to the priority document as Appendix C, by China Mobile in consultation with the inventors herein, proposes a special timeslot (CONSIDERATIONS OF LTE FS2 OPTIMIZATION, presentation dated Oct. 17, 2007). These teachings are seen to improve in certain respects upon FS2 as compared to any of those other proposals, and are applicable for a frame structure for use in other wireless systems beyond only LTE.

### SUMMARY

In accordance with one exemplary aspect of the invention there is a method that includes scheduling radio resources according to a frame structure that comprises a first time slot followed by a plurality of other time slots each having a length that is either a second length or a first length that is approximately double the second length. The method further includes sending transmissions in downlink ones of the plurality of other time slots and receiving transmissions in uplink ones of the plurality of other timeslots.

In accordance with another exemplary aspect of the invention there is an apparatus that includes a processor that is configured to schedule radio resources according to a frame structure that comprises a first time slot followed by a plurality of other time slots each having a length that is either a second length or a first length that is approximately double the second length. The processor is further configured to cause transmissions to be sent from a transmitter in downlink ones of the plurality of other time slots, and configured to cause transmissions to be received by a receiver in uplink ones of the plurality of other timeslots.

In accordance with yet another exemplary aspect of the invention there is a memory storing a program of computer readable instructions that are executable by a processor for scheduling radio resources according to a frame structure that comprises a first time slot followed by a plurality of other time slots each having a length that is either a second length or a first length that is approximately double the second length. The executed instructions are further for causing transmissions to be sent in downlink ones of the plurality of other time slots and transmissions to be received in uplink ones of the plurality of other timeslots.

In accordance with still a further exemplary aspect of the invention there is an apparatus that includes processing means (e.g., a processor), sending means (e.g., a transmitter), and receiving means (e.g., a receiver). The processing means is for scheduling radio resources according to a frame structure that comprises a first time slot followed by a plurality of other time slots each having a length that is either a second length or a first length that is approximately double the second length. The sending means is for sending transmissions in downlink ones of the plurality of other time slots. And the receiving means is for receiving transmissions in uplink ones of the plurality of other timeslots.

### BRIEF DESCRIPTION OF THE DRAWINGS

The foregoing and other aspects of these teachings are made more evident in the following Detailed Description, when read in conjunction with the attached Drawing Figures.

FIG. 1 is a prior art schematic diagram of a frame according to frame structure 2 as that structure is understood in the prior art previous to this invention.

FIG. 2 show simplified block diagrams of various electronic devices that are suitable for use in practicing the exemplary embodiments of this invention.

FIG. 3 is a schematic diagram showing UL/DL allocations in a frame structure according to an embodiment of this invention.

FIG. 4A is a schematic diagram similar to FIG. 3 showing other UL/DL allocations.

FIG. 4B is a schematic diagram showing further reduction of the UL/DL allocation options of FIG. 3 according to an embodiment particularly advantageous for the case where static UL/DL allocation is in use.

FIG. 5A reproduces a portion of FIG. 1.

FIG. 5B is a schematic diagram showing the subframe of FIG. 5A adapted according to an embodiment of this invention.

FIG. 6 is a graph showing block error rate BLER performance for a conventional FS1, conventional FS2, and a frame structure according to this invention designated FS3.

FIG. 7 is a graph similar to FIG. 6 showing throughput performance.

FIG. 8 is a process flow diagram illustrating an exemplary embodiment of the invention.

### DETAILED DESCRIPTION

Embodiments of this invention relate to a new frame structure that is particularly advantageous in an LTE system, but these teachings are not limited only to LTE wireless communication systems but are applicable to any wireless communication system that uses a frame structure. The description below is in the context of an LTE system though the detailed implementations are presented as examples and are not intended to serve as a limit to the broader teachings they illustrate.

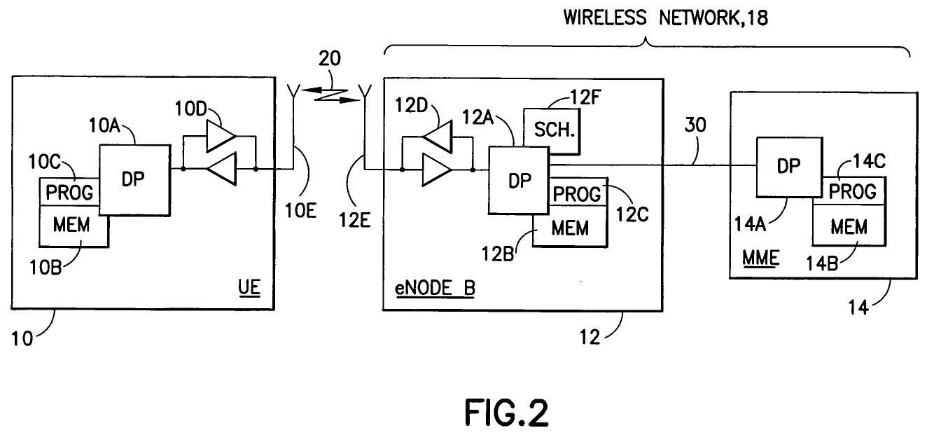

Reference is now made to FIG. 2 for illustrating a simplified block diagram of various electronic devices that are suitable for use in practicing the exemplary embodiments of this invention. In FIG. 2 a wireless network 18 is adapted for communication between a UE 10 and a Node B 12 (e-Node B). The network 18 may include a gateway GW/serving mobility entity MME/radio network controller RNC 14 or other radio controller function known by various terms in different wireless communication systems. The UE 10 includes a data processor (DP) 10A, a memory (MEM) 10B that stores a program (PROG) 10C, and a suitable radio frequency (RF) transceiver 10D (e.g., separate or combined transmitter and receiver) coupled to one or more antennas 10E (one shown) for bidirectional wireless communications over one or more wireless links 20 with the Node B 12 over which communications are sent using the frame structures according to embodiments of this invention as detailed below.

The terms “connected, ” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The Node B 12 also includes a DP 12A, a MEM 12B, that stores a PROG 12C, and a suitable RF transceiver 12D coupled to one or more antennas 12E. The Node B 12 may be coupled via a data path 30 (e.g., lub or S1 interface) to the serving or other GW/MME/RNC 14. The GW/MME/RNC 14 includes a DP 14A, a MEM 14B that stores a PROG 14C, and a suitable modem and/or transceiver (not shown) for communication with the Node B 12 over the lub link 30.

Also within the node B 12 is a scheduler 12F which may be embodied within the DP 12A that schedule the various UEs under its control for the various UL and DL subframes. Once scheduled, the Node B sends messages to the UEs with the scheduling grants (typically multiplexing grants for multiple UEs in one message for LTE systems). Generally, the Node B 12 of an LTE system is fairly autonomous in its scheduling and need not coordinate with the GW/MME 14 excepting during handover of one of its UEs to another Node B.

At least one of the PROGs 10C, 12C and 14C is assumed to include program instructions that, when executed by the associated DP, enable the electronic device to operate in accordance with the exemplary embodiments of this invention, as detailed above. Inherent in the DPs 10A, 12A, and 214A is a clock to enable synchronism among the various apparatus for transmissions and receptions within the appropriate time intervals and slots required, as the scheduling grants and the granted resources/subframes are time dependent.

The PROGs 10C, 12C, 14C may be embodied in software, firmware and/or hardware, as is appropriate. In general, the exemplary embodiments of this invention may be implemented by computer software stored in the MEM 10B and executable by the DP 10A of the UE 10 and similar for the other MEM 12B and DP 12A of the Node B 12, or by hardware, or by a combination of software and/or firmware and hardware in any or all of the devices shown.

In general, the various embodiments of the UE 10 can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Wireless communications across the link 20 are parsed into frames and subframes, and both the UE 10 and the eNodeB 12 (base station) know the frame structure in advance to avoid excessive signaling overhead. According to an embodiment of the invention the frame structure is specified with a numerology either based 20736×Tₛ=0.675 ms or 41472×Tₛ=1.35 ms TS length for DL and UL allocation.

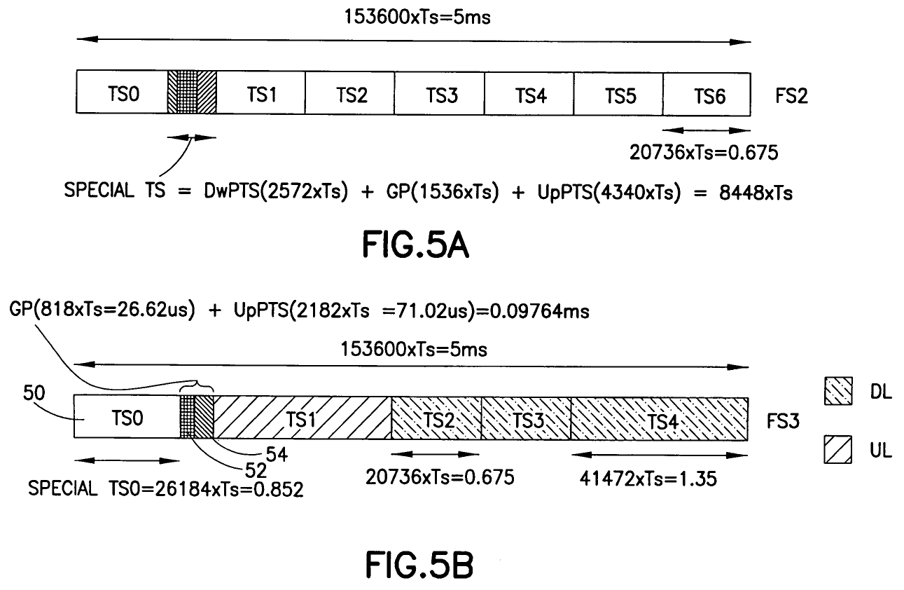

That larger TS length allows the inventors to revisit the numerology for a new frame structure and aim at improving the frame efficiency—namely (i) cyclic prefix overhead; (ii) number of OFDM/SC-FDMA (single carrier-frequency division multiple access) symbols per transmit time interval (TTI), and (iii) more efficient special timeslot design. An embodiment of the invention showing improved frame efficiency is shown at FIGS. 5A-5B.

A larger TTI on the UL allows longer transmission time for UEs on the edge of the cell while transmitting in narrow-band frequency allocation at maximum UE power transmission. As TTI is longer, more robust AMC and HARQ may be used with same payload. This helps coverage for those UEs at the edge of the cell.

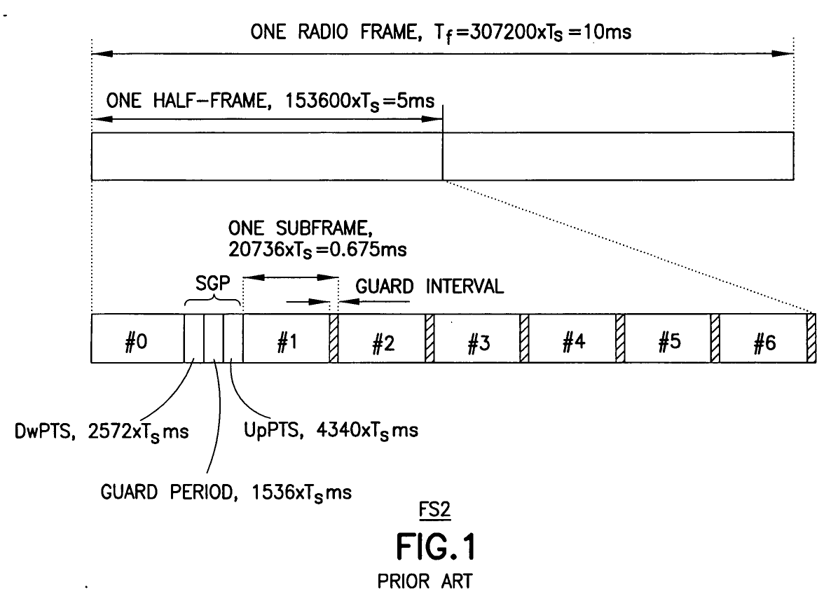

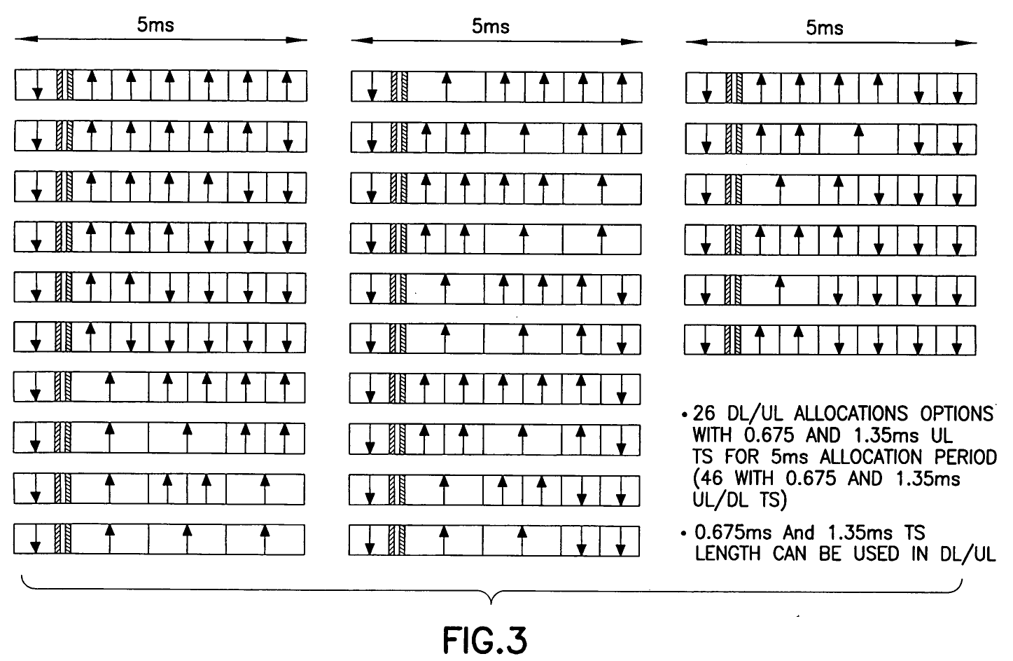

According to an embodiment of this novel frame structure, there are a number of DL/UL allocation options for a 5 ms allocation period (one half frame or subframe, see FIG. 1) with 0.675 ms or 1.35 ms DL/UL TS. Also according to an embodiment of this invention a special TS0 may have a different size, detailed further below and at FIG. 5B, and this special TS0 gives even more options for the subframe/frame that is actually transmitted. The selected group of the possible DL/UL allocation options shown in the example at FIG. 3 is limited to the longer 1.35 ms subframe is used only for the UL TSs. For example, 26 such unique options are shown in FIG. 3, expandable to 46 when 1.35 ms DL allocation TSs are considered. The leading six subframes in the left column of FIG. 3 is expanded in the remainder of FIG. 3 for those 1.35 ms UL subframes. A subset of DL/UL allocation options may be used based on some assumptions as detailed below to reduce the number of DL/UL allocations.

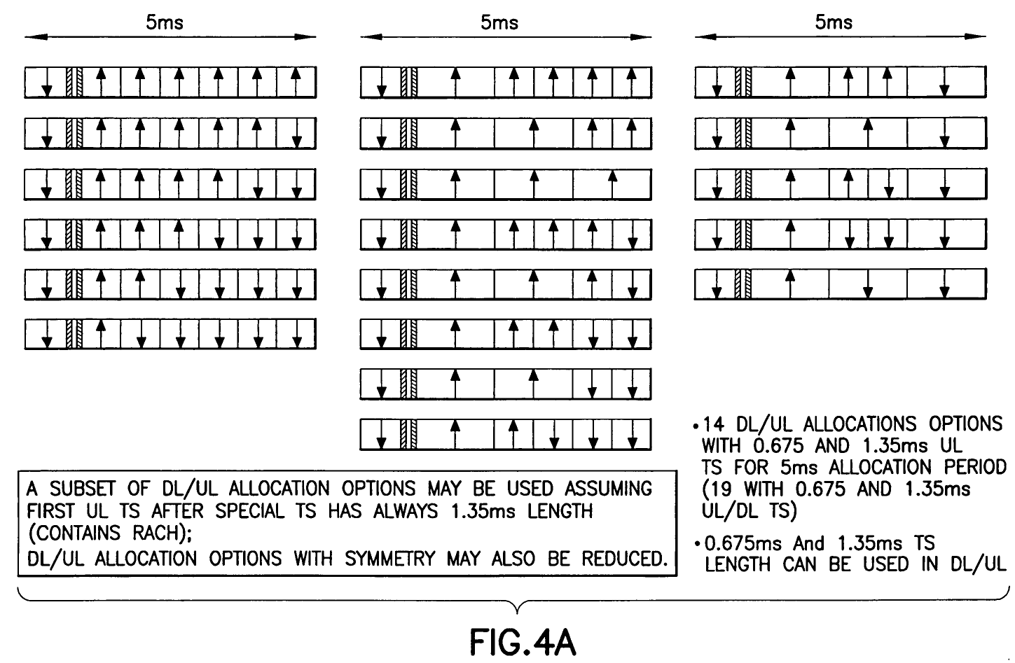

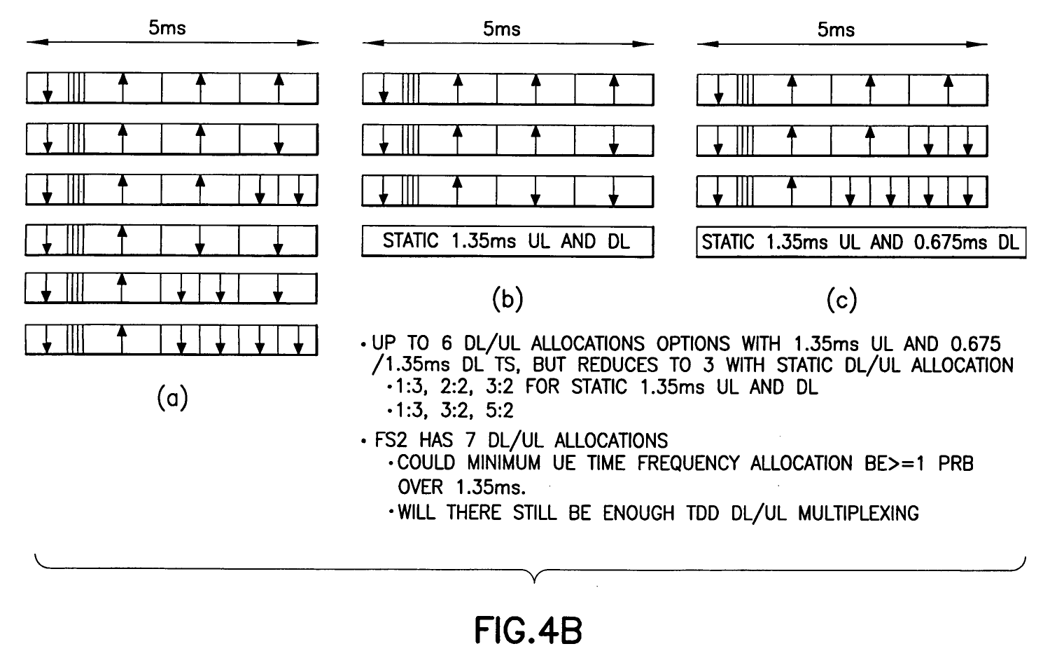

According to an embodiment of this invention, a subset of DL/UL allocation options may be used assuming the first UL TS after a special TS, namely TS1, has always a 1.35 ms length (and contains the RACH) as shown in the center and right columns of FIG. 4A. DL/UL allocation options with symmetry may also be reduced. This gives a subset of 14 DL/UL allocation options (with 0.675 and 1.35 ms TS length for UL and 0.675 ms TS length for DL) for a 5 ms allocation period, or a subset of 19 DL/UL allocations options (with 0.675 and 1.35 ms TS lengths for UL and DL) as illustrated across all three columns of FIG. 4A. This subset of 19 can be further reduced to 14 if DL with only 0.675 ms TS length is in use (left and center columns of FIG. 4A). A particular embodiment of this invention may further reduce the subset of DL/UL allocations in case static DL/UL allocation is in use to (i) 6 configuration options if UL TS is always 1.35 ms length (static allocation in UL), and DL TS can be either 0.675 ms or 1.35 ms length (dynamic allocation in DL) as shown on FIG. 4B at column (a); (ii) 3 configuration options if UL TS is always 1.35 ms (static allocation in UL), and DL TS is always 1.35 ms length (static allocation in DL) as shown on FIG. 4B at column (b); and (iii) 3 configuration options if UL TS is always 1.35 ms (static allocation in UL), and DL TS is always 0.675 ms length (static allocation in DL) as shown on FIG. 4B at column (c). The static DL/UL allocations of FIG. 4B are exemplary only; other static allocations are certainly available within the confines of the novel frame structure of these teachings. This depends on how effective the frequency domain packet scheduling (FDPS) can be with the smaller TS length in DL, which may be studied further for the optimized combination. Using a frame structure as proposed above enables a sufficiently large number of DL/UL allocation options to provide the required granularity in the time domain so as to flexibly allocate resources to DL and UL. Packet scheduling algorithms may also be optimized in order to more efficiently comport data with these DL/UL allocation options, and mapping of the physical downlink shared channel PDSCH and the physical uplink shared channel PUSCH can be readily matched to the DL/UL TSs detailed herein.

Understanding the flexibility of the TSs within the 5 ms subframe noted above, it is straight-forward to extend the 5 ms allocation options to 10 ms allocation options provided that there is only a single UL/DL switching point within a longer time-period. Such an extension is not detailed further but follows directly from the subframe description above; the single UL/DL switching point noted above for the 5 ms subframe (between TS1 and TS6) may be applied across the whole 10 ms radio frame.

A subframe with a short CP according to an embodiment of the invention is illustrated in FIG. 5B, recognizing that this example can be readily adapted for an extended CP also. FIG. 5A is a reproduction of the subframe from FIG. 1 to more clearly show the distinctions in FIG. 5B. Some of the time occupied by the special TS in FS2 (designated in FIG. 1 as SGP which includes DwPTS, GP and UpPTS) may be combined with TS0 to form a new timeslot referred in FIG. 5B as special TS0 50. TS0 is always a DL slot, and so is special TS0 50. The special DL timeslot, TS0, has length 12×(2048+134)×Tₛ=26184×Tₛ=0.852 ms with 12 OFDM symbols, each with length (2048+134)×Tₛ=71.02 us (as above, this includes the short CP=134×Tₛ=4.36 us).

Further in FIG. 5B, the special TS0 50 is followed by (without a DwPTS) a guard period 52 of 818×Tₛ=26.62 us, and an SC-FDMA (single carrier frequency division multiple access) symbol 54. The total length is calculated as 12×(2048+134)×Tₛ (the special TS0 50)+GP (52)+1×(2048+134)×Tₛ (the SC-FDMA symbol 54)=(20736+8448)×Tₛ, which is the total length of the current TS0 and special TS/SGP in FS2 according to the prior art (see FIGS. 1 and 5A). The GP 52 is a transmission gap that allows DL/UL switching and synchronization for cell size of up to 4 km radius (assuming a propagation delay of 3.33 us per km and that the guard period allows for 2 times maximum propagation delay). The GP 52 is followed by an SC-FDMA symbol 54 of length (2048+134)×Tₛ=71.72 us in lieu of the UpPTS for RACH or data/control transmission on the UL. Following the SC-FDMA symbol 54, the remainder of the subframe is made up of TSs of length either 0.675 ms or 1.35 ms, of which one DL/UL allocation option is shown at FIG. 5B, and other examples are shown at FIGS. 3-4.

So in the example of FIG. 5B:
DL TS2, TS3 have length 20736×Tₛ=0.675 ms each with 9 OFDM/SC-FDMA symbols and CP as specified for FS2 DL TS [see 3GPP TS 36.211 v8.0.0 at Appendix D of the priority document];
DL TS4 has length 2×20736×Tₛ=41472×Tₛ=1.35 ms with 19 OFDM symbols of length (2048+134)×Tₛ=71.72 Ãs for short CP=134×Tₛ=4.297 us in positions I=1, 2, . . . , 18 and length (2048+148)×Tₛ=71.48 us for CP=148×Tₛ=4.81 us in position I=0 in timeslot;
UL TS1 has length 2×20736×Tₛ=41472×Tₛ=1.35 ms with 19 OFDM symbols of length (2048+134)×Tₛ=71.72 us for short CP=134×Tₛ=4.297 us in positions I=1, 2, . . . , 18 and length (2048+148)×Tₛ=71.48 us for CP=148×Tₛ=4.81 us in position I=0 in timeslot;

As can be seen by the example at FIG. 5B, the long TSs have more than double the number of symbols than the shorter TSs (19 versus 8), wherein the length is only double that of the short TSs. Note that each long TS uses a mixture of both long and short cyclic prefixes CPs across its 19 symbols. There is still only one GP prior to TS1 in the subframe; GP 52, which at 818 Tₛ is about one half the length of the GP in the prior art FS2 of FIG. 5A, yet which still allows switching between UL and DL TSs.

Mapping of the primary synchronization channel P-SCH and the secondary synchronization channel S-SCH (e.g., every 5 ms) could be done in symbol position #11 and #10 respectively in the first TS0 in a 5 ms radio subframe for compatibility with TD-SCDMA (time division-synchronous code division multiple access) or in symbol positions #1 and #2 for compatibility with FDD. Six PRBs are reserved in the inventive frame structure for P-SCH or S-SCH in a central 1.25 MHz bandwidth. The remaining PRBs for larger bandwidth options may be used for data or signaling. This improves frame efficiency by up to 1/(9*7)=1.6% as compare to FS2 of the prior art.

The broadcast channel BCH may be mapped (e.g., every 10 ms) to TS0 in the first radio frame of 10 ms.

In the special TS example, a GP of about 26.62 us is shown, which allows for a cell radius of up to 4 km. Larger GP for cell sizes exceeding 4 km may be simply constructed by stealing symbols from TS1, albeit at the cost of lower frame efficiency. A UL/DL switching point per 5 ms may be simply obtained by stealing one SC-FDMA symbol for UDSP or (2048+134)×Tₛ in case TS length of 1.35 ms is used, or the UDSP as specified in 3GPP TS 36.211 (Appendix D of the priority document) if TS length 0.675 ms is used. Hence, the frame structure according to an embodiment of these teachings using the larger TS has about 26% higher UDSP overhead than FS2 of the prior art ((2048+134)×Tₛ vs (288×6)×Tₛ) at the cost of a marginal loss of frame efficiency of about 0.3%.

Mapping of the RACH may be done to SC-FDMA symbol (in lieu of UpPTS) and adjacent symbols in TS1. The remaining PRBs for larger bandwidth options may be used for data or signaling if not used by RACH. This improves frame efficiency by up to 1/(9*7)=1.6% compare to FS2 of the prior art. The number of symbols for RACH, the choice of RACH preamble sequence and RACH repetition (time or frequency) may also be further adapted to most efficiently interface with the novel frame structure detailed herein.

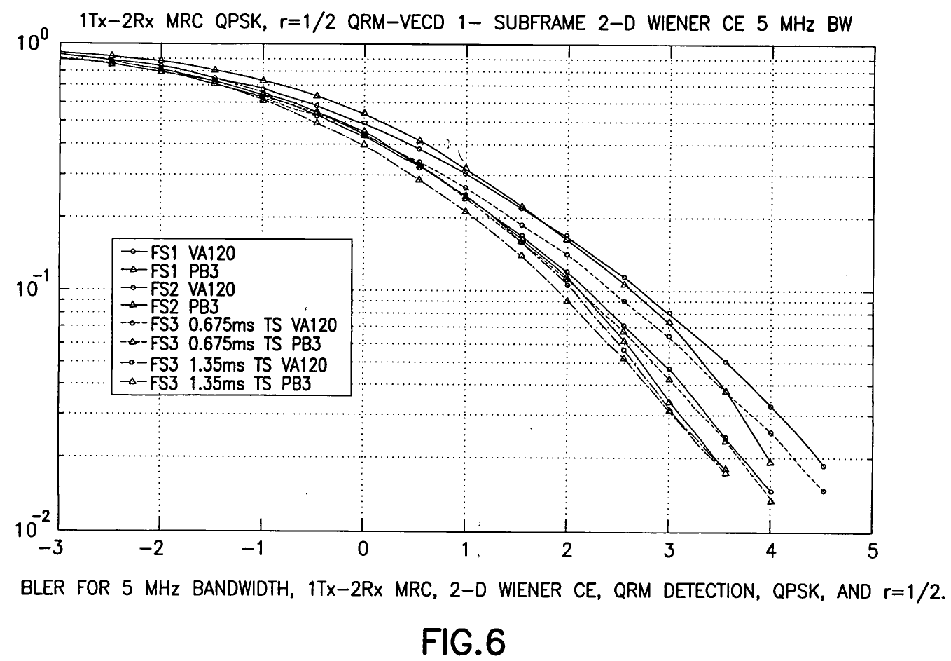

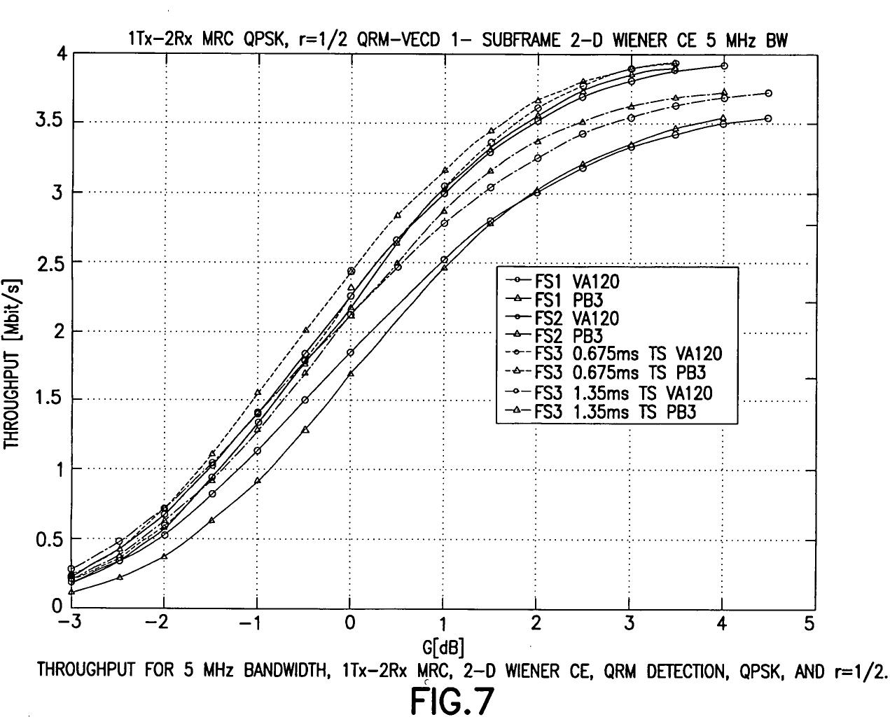

Some receiver algorithms may be shared between frame structures FS1, FS2, and the new frame structure detailed herein. An important difference is in the scheduling of baseband BB receiver functions and buffer sizes. Exactly the same receiver algorithms were simulated in BLER and through performance plotted at FIGS. 6-7.

The frame structure disclosed herein [assuming a structure where only 1.35 ms TS length is used for DL and UL, except the special TS0 50] has up to (12+1+3*19)=70 symbols, as compared to 9*7=63 symbols for the prior art FS2 and 7*10=70 symbols for FS1. Hence, certain technical advantages of embodiments of the proposed frame structure include:
up to (70-63)/63=11.1% higher frame efficiency than FS2
up to 70/70=100% of FS1 frame efficiency (FS2 has 63/70=90%)
a CP overhead that can be as low as (12×134+1×134+18×134×3+148×3)×Tₛ/153600×Tₛ=6.1% compared to 11.74% for FS2 and 6.5% for FS1 (depending on 1.35 ms TS length allocation)

As an example, the BLER (block error rate) and throughput performance for FS1, FS2 of the prior art, and a frame structure according to these teachings (denoted by FS3) with 0.675 ms TS length and 1.35 ms TS length are shown in FIGS. 6-7 for 5 MHz bandwidth, 1Tx-2Rx antenna configuration, 2-D Wiener channel estimation, QRM detection QR decomposition, an orthogonal matrix triangulation), QPSK modulation (quadrature phase shift keying), and coding rate ½. The best BLER performance is achieved with TS length of 1.35 ms. As seen at FIG. 7, FS3 gives same throughput as FS1 and about 9.5% higher throughput than that in FS2 at high SNR; gains of 50% to 100% at medium to low SNR can be achieved. Note that FS3 is using an optimized pilot structure, but has the same pilot overhead as FS2.

The frame structure according to these teachings may use a special timeslot 50 as described with reference to FIG. 5B above. There is flexibility in the mapping of data and signalling to this special timeslot TS0 50 for either TD-SCDMA compatibility or FDD compatibility.

In an exemplary frame according to these teachings, uplink coverage may be improved by static TTI expansion in UL. This frame structure with the larger TS length of 1.35 ms in uplink provides savings on packet uplink control channel PUCCH overhead (medium access control MAC/radio link control RLC header, cyclic redundancy check CRC). Similarly, larger TS length in DL may save on downlink physical control channel DPCCH overhead. Multi-TTI UL grants may be used with the described frame structure to further improve signaling efficiency. If expanding the TTI in DL, a loss in frequency domain packet scheduling gain may be experienced and the e-Node B 12 can decide upon the tradeoff.

In both UL and DL, larger HARQ delays may sometimes be experienced when expanding the TTI when HARQ is considered. However, it may not be so. As an example of the latter, please consider the DL/UL/UL/DL/DL case (where all DLs are the short 0.675 ms TTI and the ULs are the 1.35 ms expanded TTI). The UL HARQ delays (assuming 2.025 ms eNode B 12 processing and 2.025 ms UE 10 processing including 2× time alignment compensation) would be 10 ms (4 stop-and-wait SAW processes needed) while for a solution DL/UL/UL/UL/UL/DL/DL (where all TSs are of the shorter 0.675 ms variety), the associated delays would be the same (for 8 SAW “smaller” processes with same total memory).

As an example of a small delay increase consider the case DL/UL/DL/DL/DL/DL (where all are 0.675 ms TSs except the UL which is a 1.35 ms TS) versus DL/UL/UL/DL/DL/DL/DL (where all TSs are 0.675 ms). In the former case, a 10 ms HARQ delay is experienced and two HARQ processes are needed. With a DL/UL/UL/DL/DL/DL solution (where all TSs are the shorter 0.675 ms variety), only 2 SAW processes are needed and only a 5 ms delay results. As for selection of TTI expansions in downlink, the eNode B 12 can make a tradeoff among coverage improvements and HARQ delays in the cell depending on the scenario.

Channel estimation on the UL and DL should benefit from longer TS length, as typical 2-D Wiener filtering of linear minimum mean square error LMMSE channel estimates works better with more samples. This novel frame structure is compatible with the existing pilot specification for DL and UL FS2 of the prior art, though further optimization of pilot structure may also yield fine-tuned improvements to implement with this frame structure.

The frame structure with larger TS according to these teachings can have the same timing parameters for UL and DL as is the case for FS1—i.e. cyclic prefix length, symbol length. This simplifies implementation with other aspects of LTE.

The reduced subset of DL/UL allocation options given as examples with reference to FIG. 3-4 includes the DL/UL allocation options used in FS2 of the prior art to maintain high compatibility with TD-SCDMA in case the network operator (MME 14 ore Node B 12) deploys LTE TDD and TD-SCDMA on adjacent carriers and requires maximum granularity in the time domain.

For the aspects of this invention related to the network, embodiments of this invention may be implemented by computer software executable by a data processor of the e-Node B 12, such as the processor 12A shown, or by hardware, or by a combination of software and hardware. For the aspects of this invention related to the mobile users, embodiments of this invention may be implemented by computer software executable by a data processor of the UE 10, such as the processor 10A shown, or by hardware, or by a combination of software and hardware. Further in this regard it should be noted that the various logical step descriptions above may represent program steps, or interconnected logic circuits, blocks and functions, or a combination of program steps and logic circuits, blocks and functions. The frame structure(s) that the e Node B 12 might use in signaling to the UE 10 may be specified in a published wireless protocol and stored in a local memory MEM of the e-Node B 12 and UE 10.

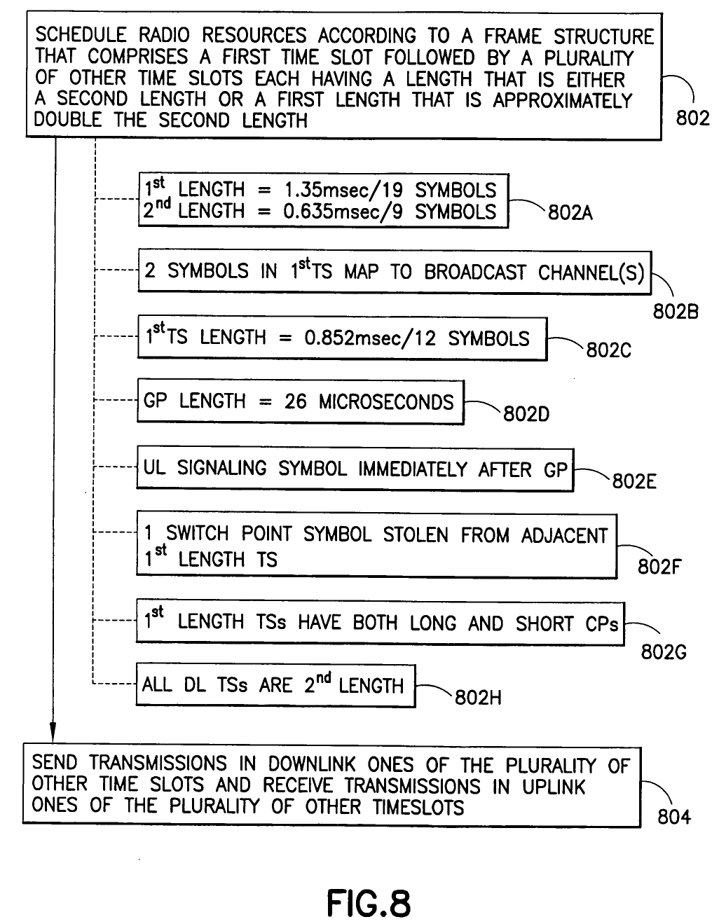

According to various embodiments of the invention and as illustrated at FIG. 8 is a method, apparatus and memory embodying a computer program causing a message to be sent according to a frame structure as shown at block 802 that includes a first time slot followed by a plurality of time slots, at least one of which has a first length (e.g., 1.35 ms as seen at block 802A) that is approximately double that of another of the plurality of time slots which has a second length (e.g., 0.675 ms also shown at block 802A). The message according to the frame structure is then sent to a user equipment, and the user equipment receives the message and decodes it according to the frame structure. At block 804 the downlink transmissions are sent and the uplink transmissions are received by the eNB according to the frame structure. In an embodiment, the first time slot has a third length between the first length and the second length as shown particularly at block 802C. In an embodiment, the first time slot is a downlink time slot and the next subsequent time slot is an uplink time slot of the first length, and a guard period is disposed between the first time slot and the next subsequent time slot that is shorter than a guard period according to the prior art frame structure 2, shown particularly as 26 microseconds at block 802D. In an embodiment, all time slots of the plurality of time slots are of either the first or the second length, and all downlink time slots are of the second length as seen at block 802H. In an embodiment, the timeslots having the first length carry more than double the symbols than are carried by the timeslots having the second length, as seen at block 8021A by example. In another embodiment two symbols of the first TS map to the primary and secondary broadcast channels as shown at block 802C. At block 802E there is an uplink signaling symbol disposed between the guard period and the timeslot immediately following the guard period. Block 802F shows that the single UL/DL switch point among the other timeslots is a symbol stolen from a 1^{st} length TS adjacent to that switch point, and at block 802G is it shown that the 1^{st} length TSs have both long and short cyclic prefixes disposed within them. Each of elements 802A-H may be used alone or in any combination to achieve the overall frame structure.

In general, the various embodiments may be implemented in hardware or special purpose circuits, software (computer readable instructions embodied on a computer readable medium), logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above, or from the scope of the ensuing claims.

1. A method comprising:
scheduling radio resources according to a frame structure that comprises a first time slot followed by a plurality of other time slots each having a length that is either a second length or a first length that is approximately double the second length; and
sending transmissions in downlink ones of the plurality of other time slots and receiving transmissions in uplink ones of the plurality of other timeslots.

2. The method of claim 1, wherein:
the first length is one of approximately 1.35 milliseconds and nineteen symbols; and
the second length is one of approximately 0.675 milliseconds and nine symbols.

3. The method of claim 1, wherein each of the plurality of other time slots are traffic time slots.

4. The method of claim 1, wherein at least two symbol positions of the first time slot are used for mapping to a primary broadcast channel and to a secondary broadcast channel.

5. The method of claim 1, wherein the first time slot has a length between the first length and the second length.

6. The method of claim 5, wherein:
the first time slot is a downlink time slot having a length that is one of approximately 0.852 milliseconds and twelve symbols.

7. The method of claim 5, wherein one of the plurality of other time slots which next follows the first time slot is a subsequent time slot which is an uplink timeslot having the first length; and
a guard period having length approximately 26 micro-seconds is disposed between the first time slot and the subsequent time slot.

8. The method of claim 7, wherein a single symbol is disposed between the guard period and the subsequent time slot for uplink signaling.

9. The method of claim 1, wherein all downlink time slots of the plurality of other time slots are of the second length.

10. The method of claim 1, wherein all of the plurality of other timeslots which have the first length carry a mixture of both long and short cyclic prefixes and further carry more than double a number of symbols than are carried by any of the plurality of other timeslots which have the second length.

11. The method of claim 1, wherein the frame structure defines a subframe of length 5 ms in which a single switching point divides all uplink ones of the plurality of other frames from all downlink ones of the plurality of other frames, wherein the switching point comprises a single symbol stolen from one of the plurality of other frames which has the first length and which is adjacent to the switching point.

12. An apparatus comprising:
a processor configured to schedule radio resources according to a frame structure that comprises a first time slot followed by a plurality of other time slots each having a length that is either a second length or a first length that is approximately double the second length; and
the processor configured to cause transmissions to be sent from a transmitter in downlink ones of the plurality of other time slots and configured to cause transmissions to be received by a receiver in uplink ones of the plurality of other timeslots.

13. The apparatus of claim 12, wherein:
the first length is one of approximately 1.35 milliseconds and nineteen symbols; and
the second length is one of approximately 0.675 milliseconds and nine symbols.

14. The apparatus of claim 12, wherein the apparatus comprises an access node of a wireless communication network and the apparatus comprises the transmitter and the receiver;
and wherein each of the plurality of other time slots are traffic time slots.

15. The apparatus of claim 12, wherein the processor is configured to use at least two symbol positions of the first time slot for mapping to a primary broadcast channel and to a secondary broadcast channel.

16. The apparatus of claim 12, wherein the first time slot has a length between the first length and the second length.

17. The apparatus of claim 16, wherein:
the first time slot is a downlink time slot having a length that is one of approximately 0.852 milliseconds and twelve symbols.

18. The apparatus of claim 16, wherein one of the plurality of other time slots which next follows the first time slot is a subsequent time slot which is an uplink timeslot having the first length; and
the processor is configured to dispose a guard period having length approximately 26 micro-seconds between the first time slot and the subsequent time slot.

19. The apparatus of claim 18, wherein the processor is configured to dispose a single symbol between the guard period and the subsequent time slot for uplink signaling.

20. The apparatus of claim 12, wherein all downlink time slots of the plurality of other time slots are of the second length.

21. The apparatus of claim 12, wherein the processor is configured to dispose a mixture of both long and short cyclic prefixes in each of the plurality of other timeslots which have the first length and further to dispose in each of the plurality of other timeslots which have the first length more than double a number of symbols than the processor is configured to dispose in any of the plurality of other timeslots which have the second length.

22. The apparatus of claim 12, wherein the frame structure defines a subframe of length 5 ms in which the processor is configured to dispose a single switching point to divide all uplink ones of the plurality of other frames from all downlink ones of the plurality of other frames, wherein the processor is configured to dispose the switching point as a single symbol stolen from one of the plurality of other frames which has the first length and which is adjacent to the switching point.

23. A memory storing a program of computer readable instructions executable by a processor for:
scheduling radio resources according to a frame structure that comprises a first time slot followed by a plurality of other time slots each having a length that is either a second length or a first length that is approximately double the second length; and
causing transmissions to be sent in downlink ones of the plurality of other time slots and transmissions to be received in uplink ones of the plurality of other timeslots.

24. The memory of claim 23, wherein:
the first length is one of approximately 1.35 milliseconds and nineteen symbols; and
the second length is one of approximately 0.675 milliseconds and nine symbols.

25. The memory of claim 23, wherein at least two symbol positions of the first time slot are used for mapping to a primary broadcast channel and to a secondary broadcast channel.

26. The memory of claim 23, wherein the first time slot has a length between the first length and the second length.

27. The memory of claim 26, wherein one of the plurality of other time slots which next follows the first time slot is a subsequent time slot which is an uplink timeslot having the first length; and
a guard period having length approximately 26 micro-seconds is disposed between the first time slot and the subsequent time slot.

28. The memory of claim 27, wherein a single symbol is disposed between the guard period and the subsequent time slot for uplink signaling.

29. The memory of claim 23, wherein the frame structure defines a subframe of length 5 ms in which a single switching point divides all uplink ones of the plurality of other frames from all downlink ones of the plurality of other frames, wherein the switching point comprises a single symbol stolen from one of the plurality of other frames which has the first length and which is adjacent to the switching point.

30. An apparatus comprising:
processing means for scheduling radio resources according to a frame structure that comprises a first time slot followed by a plurality of other time slots each having a length that is either a second length or a first length that is approximately double the second length; and
sending means for sending transmissions in downlink ones of the plurality of other time slots; and
receiving means for receiving transmissions in uplink ones of the plurality of other timeslots.

31. The apparatus of claim 30, wherein
the first length is one of approximately 1.35 milliseconds and nineteen symbols; and
the second length is one of approximately 0.675 milliseconds and nine symbols.
